(19) United States
(12) Patent Application Publication
(10) Pub. No.: US 2011/0024994 A1
(43) Pub. Date: Feb. 3, 2011

(54) SEAL HAVING A LARGE COMPRESSION RANGE

(75) Inventor: Serge Bunel, Le Havre (FR)

Correspondence Address: CANTOR COLBURN LLP, 20 Church Street, 22nd Floor, Hartford, CT, 06103, US

(73) Assignee: AIRCELLE, Gonfreville L' Orcher (FR)

(21) Appl. No.: 12/674,066

(22) PCT Filed: Aug. 8, 2008
(86) PCT No.: PCT/FR08/01181

§ 371 Date: Feb. 18, 2010

(30) Foreign Application Priority Data
Aug. 20, 2007 (FR) 0705933

(51) Int. Cl. F16J 15/10

(52) U.S. Cl. 277/637; 277/650

(57) ABSTRACT

The invention relates to a seal (1) designed to be inserted between a cowl (51) of a rear section of a nacelle and a turbojet of an aircraft propulsion unit. Said seal (1) includes a cylindrical portion (2) and at least one lip (3) extending radially from a generatrix of the cylindrical part (2).

### TECHNICAL FIELD

The invention relates to a seal intended to be interposed between a turbojet and a nacelle of an aircraft.

### BACKGROUND

An aircraft is propelled by a number of turbojets each housed in a nacelle; each nacelle also accommodates a collection of auxiliary actuation devices associated with its operation and performing various functions when the turbojet is operating or stationary.

As shown in FIG. 2, a nacelle generally has a tubular structure comprising:
(i) an air inlet 20 in front of a turbojet 30,
(ii) a mid-section 40 intended to surround a fan of the turbojet,
(iii) a rear section 50 which may optionally incorporate thrust reversal means and is intended to surround the combustion chamber of the turbojet 30, and
(iv) an exhaust nozzle 60 whose outlet is situated downstream of the turbojet.

Modern nacelles are often intended to accommodate a bypass turbojet which, via the rotating fan blades, is designed to generate a hot air flow (also termed primary flow) from the combustion chamber of the turbojet.

A nacelle generally has an outer structure, termed Outer Fixed Structure (OFS), which, together with a concentric inner structure, termed Inner Fixed Structure (IFS), comprising a cowl surrounding the actual turbojet structure behind the fan, defines an annular flow duct, also termed flow path, aimed at channeling a cold air flow, termed secondary flow, which circulates outside the turbojet. The primary and secondary flows are ejected from the turbojet via the rear of the nacelle.

Each propulsion unit of the aircraft is thus formed by a nacelle and a turbojet, and is suspended from a fixed structure of the aircraft, for example below a wing or on the fuselage, by means of a pylon or a strut attached to the turbojet or to the nacelle.

The rear section of the outer structure of the nacelle is usually formed by two cowls of substantially hemicylindrical shape, on either side of a longitudinal vertical plane of symmetry of the nacelle, and operation and a maintenance position which gives access to the turbojet.

The two cowls are generally mounted pivotably about a longitudinal axis forming a hinge in the upper part of the reverser (upper junction line, at 12 o'clock). The cowls are maintained in a closure position by means of locks arranged along a junction line situated in the lower part (at 6 o'clock).

It is therefore found that an aircraft propulsion unit incorporates functional subassemblies which have relative movements and between which sealing should be managed.

In particular, it is important that the two cowls which surround the turbojet and which define the secondary stream over a portion of its course channel this secondary stream without leakage toward the turbojet 30. It is particularly important to create a sealing barrier between the upstream portion of each cowl and the turbojet so as to prevent any leakage of the secondary stream toward the turbojet. Such a leakage is particularly harmful. Specifically, the nacelle is designed and dimensioned for a channeled secondary stream which exerts a pressure on its inner structure. By contrast, the nacelle is not designed to accommodate any scooping of the flow constituting the secondary stream toward the turbojet 30; a high degree of scooping can lead to tearing of the inner structure of the nacelle.

However, sealing between the two cowls and the turbojet presents a particular set of problems. First of all, the two cowls are each moved axially and radially with respect to the turbojet. Next, given the large size of the components, the two cowls may in operation experience large movements. A seal interposed between a cowl and the turbojet must therefore create a sealing barrier irrespective of the relative position of a cowl with respect to the turbojet. Now, given the coefficient of compression of the known seals and the amplitude of the movement for which sealing should be provided, it proves to be the case that the known seals of generally omega-shaped tubular cross section cannot satisfactorily provide this sealing; this is because the known seals have a diameter incompatible with the space defined between the cowls and the turbojet.

Documents WO 2004/088081 and WO 2004/113772 describe seals comprising a cylindrical portion from which at least one lip extends. However, these seals are not fully satisfactory, in particular because they do not have a large compression capacity.

### BRIEF SUMMARY

The disclosure intends to improve the sealing between a cowl of a rear portion of a nacelle and a turbojet in an aircraft propulsion unit when they are liable to experience relative movements of large amplitudes.

The invention essentially provides a seal designed to be interposed between a cowl of a rear section of a nacelle and a turbojet of a propulsion unit of an aircraft; this seal has a cylindrical portion and at least one lip extending radially from a generatrix of the cylindrical portion and, furthermore, incorporates a longitudinal rib oriented radially toward the inside of the cylindrical portion.

Thus, the seal according to the invention has a cylindrical portion from which one or more lips extend. The seal formed according to the invention can maintain a leaktight barrier between a cowl of a rear portion of a nacelle and a turbojet in the event of relative movements of large amplitudes of these two elements. Sealing is maintained by a seal whose envelope, that is to say the volume inside which the seal is able to move, remains limited. This point is important since the annular space defined between each cowl and the turbojet is limited but is able to experience variations of large amplitude during the operation of the turbojet. The action of the or each lip, combined with the elasticity of the cylindrical portion, maintains a sealing barrier between the cowl and the turbojet irrespective of the amplitude of the movement between these two elements. Furthermore, the rib acts as a stop during complete compression of the cylindrical portion.

Thus, the invention provides a seal which combines excellent sealing and large compression capacity, the limit of which is provided by the rib.

According to a preferred arrangement of the invention, the seal has two substantially parallel lips, thereby making it possible to create a double sealing barrier. This arrangement proves to be important insofar as each cowl can experience axial and/or radial movements with respect to the turbojet.

In addition, the two lips are, for example, oriented with respect to one another in the form of a V.

To allow the fastening of the seal to a bearing surface, the cylindrical portion can incorporate a flat on its outer surface.

In a preferred manner, the flat is diametrically opposed to at least one of the lips. This configuration of the seal makes it possible to benefit fully from the elasticity of the cylindrical part and of each lip, thus making it possible to maintain contact with the surfaces to be sealed.

Preferably, the longitudinal rib bears with its back against the flat. This arrangement corresponds to an advantageous implementation of the seal in which the seal is fastened on its flat with the aim of providing a barrier between two elements capable of movement in a direction perpendicular to the flat.

The flat can be extended by a fastening sole.

In a concrete manner, the seal can be made from an elastic material of the glass or aramid fiber-reinforced silicone type.

Finally, in a very advantageous manner, the seal can have a maximum overall size/material thickness ratio of greater than 10, or even greater than 15. The maximum overall size is defined by the distance between the free end of the lip or lips and the opposite end of the cylindrical portion (for example the bearing face of the flat), the material thickness being the thickness of the seal in the cylindrical portion or at the lips. By contrast, many seals of the prior art have a large material thickness for a maximum overall size which can be of the same order of magnitude as that of the seal according to the invention, with the result that the aforementioned ratio, in the case of the seals of the prior art, is generally around 5. Thus, the invention provides a seal whose profile allows it a very high degree of compression.

The combination of the following features: radial lips, large compression capacity and presence of a longitudinal rib forming a compression stop, makes the seal according to the invention particularly high-performing.

### BRIEF DESCRIPTION OF THE DRAWINGS

For a good understanding thereof, the invention is described with reference to the appended drawing representing by way of nonlimiting example an embodiment of a seal according to the invention.

FIG. 1 is a view in cross section of an embodiment of a seal according to the invention fitted to a cowl of a rear section of a nacelle;

FIG. 2 is an exploded perspective view of an aircraft propulsion unit comprising a nacelle and a turbojet;

FIG. 3 is a partial perspective view of a rear half-section of a nacelle, showing the locations of the seals according to the invention;

FIG. 4 is an enlarged view of the detail IV in FIG. 3.

### DETAILED DESCRIPTION

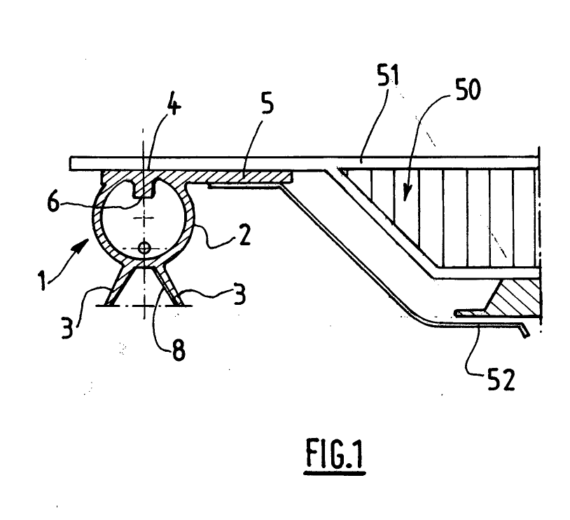

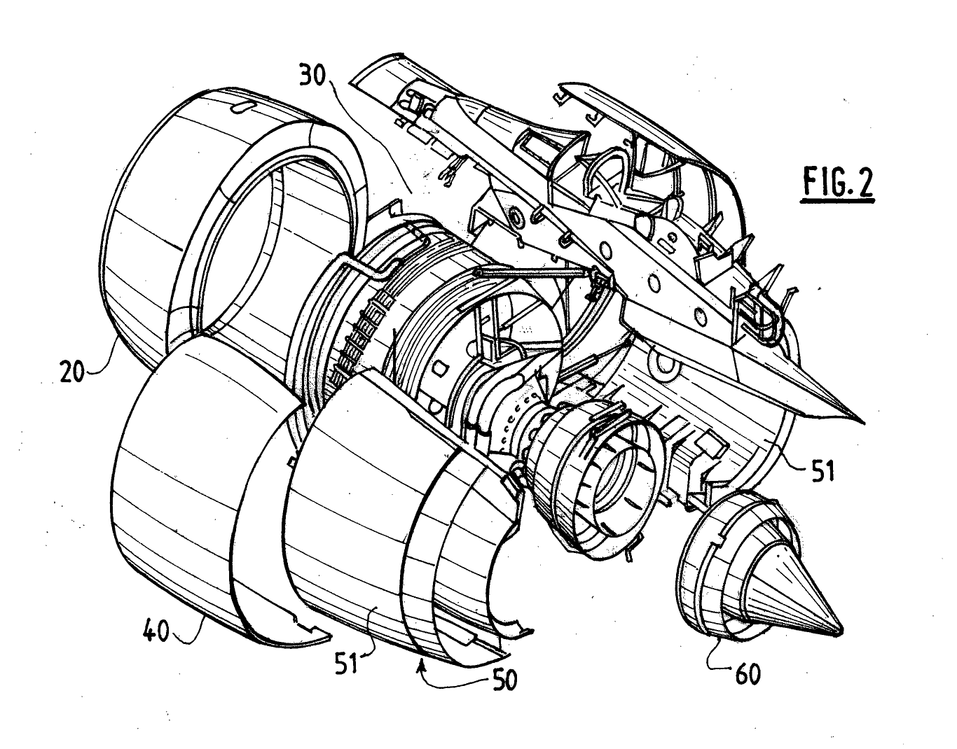

As can be seen from FIG. 1, the seal 1 according to the invention essentially comprises two portions: on the one hand, a cylindrical portion 2 which, in the example represented, presents, at rest, a circular section, and, on the other hand, two lips 3 which between them substantially form a V. The angle formed by the two lips 3 between them is around 30°. Each of the two lips 3 extends substantially radially from a generatrix of the cylindrical portion 2 toward the outside thereof.

Diametrically opposed to the two lips, the seal 1 incorporates a flat 4 on an outer surface; in the example represented, the flat 4 is extended transversally by a planar sole 5.

It will also be noted that, with its back bearing against the flat 4, the seal 1 incorporates a longitudinal rib 6 oriented toward the inside of the cylindrical portion 2.

This seal 1 can, for example, be produced by molding from an elastic material such as, for example, a silicone or an elastomer reinforced with carbon fibers or aramid fibers.

It can also be noted that a film 8 of material with a low coefficient of friction, such as, for example, PTFE, can be fixed to the seal 1. This film 8 is draped over the faces of the lips 3 which are opposite one another and also that part of the cylindrical portion 2 which is situated between the two lips 3.

As can be seen from FIG. 1, the seal 1 is affixed and is adhesively bonded to a bearing surface of a cowl 51 of a rear section of a nacelle.

To complete the fastening of the seal 1, provision can also be made to sandwich the sole between a fire protection plate 52 and the bearing surface of the cowl 51.

In operation, the seal 1, which is therefore fitted on each of the cowls 51 of the rear section of the nacelle, comes into contact with the turbojet and, more especially, comes into contact with a casing which surrounds the compressor of the turbojet 30. The seal 1 is then compressed between the cowl on which it is fitted and the casing of the turbojet 30.

During the operation of the turbojet, each of the two cowls 51 may experience movements of large amplitude in a radial direction but also in an axial direction with respect to the turbojet 30. By way of illustration, movements can be found between a cowl 51 and the turbojet 30 whose amplitude can be around 20 mm.

The seal 1 according to the invention therefore makes it possible to maintain a contact in all circumstances and therefore to create a leaktight barrier between the casing of the turbojet 30 and a cowl 51, even when the radial amplitude is maximum. The seal 1 according to the invention offers a high compression capacity which is manifested, firstly, by a bending of the two lips 3 which have a relatively low stiffness and at all events lower than that of the cylindrical portion 2; secondly, when the radial amplitude increases subsequent to the movement of the cowl 51 with respect to the turbojet 30, the cylindrical portion 2 is able to compress to such an extent as to bear against the longitudinal rib 6.

In the case of relative movement of a cowl 51 of the nacelle with respect to the turbojet 30 in an axial direction, the seal 1 maintains sealing by virtue of its two lips 3 which are able to follow the movements of the cowl.

The invention thus provides a seal 1 which makes it possible to maintain a leaktight barrier between two elements which are liable to experience relative movements of large amplitude, the envelope of this seal 1, that is to say the volume inside which the seal 1 is able to move, remaining limited, however. The seal according to the invention thus makes it possible to prevent any scooping of the secondary stream toward the turbojet. This result is obtained by an elastic cylindrical portion 2 combined with one, and preferably two, lips which provide contact in the case of movement of large amplitudes.

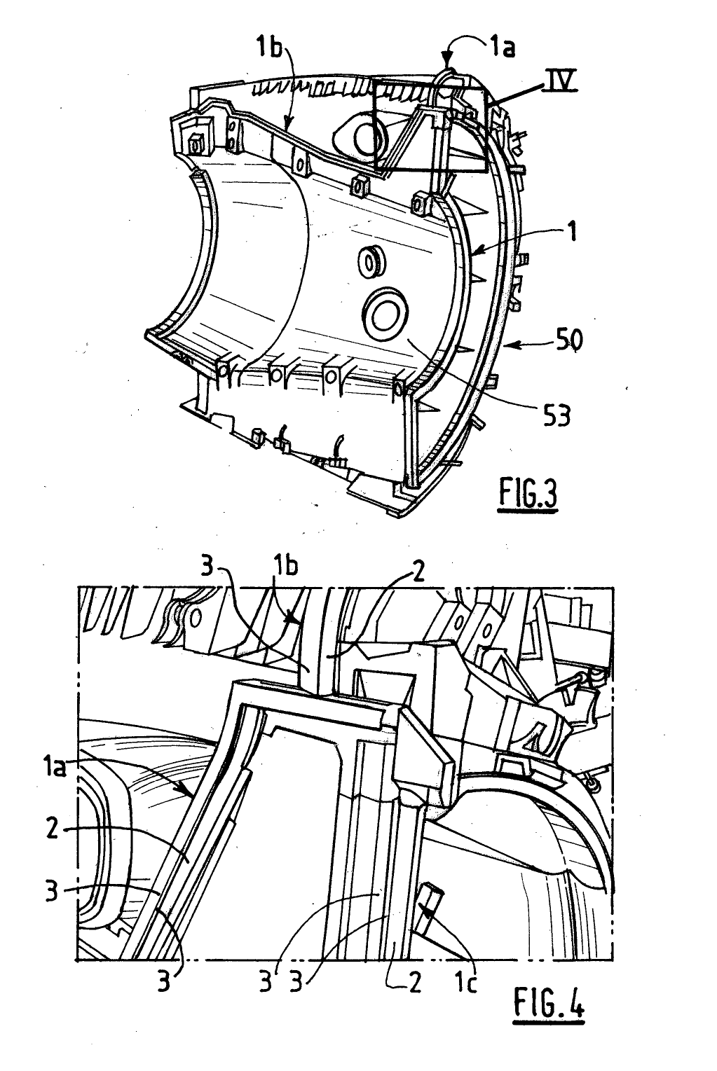

As illustrated in FIGS. 3 and 4, a seal 1 according to the invention can be placed, on the rear section 50 of the nacelle:
at the upper junction line (reference 1a);
in the junction region with the front frame of the nacelle (reference 1b);
and/or on the IFS 53, at the front (reference 1c).

Of course, the invention is not limited to the embodiment described above by way of nonlimiting example but it covers all the embodiments thereof. Thus, the fastening sole could extend on either side of the flat.

1. A seal designed to be interposed between a cowl of a rear section of a nacelle and a turbojet of a propulsion unit of an aircraft, said seal comprising:
a cylindrical portion and
at least one lip extending radially from a generatrix of the cylindrical portion,
wherein the seal incorporates a longitudinal rib oriented radially toward an inside of the cylindrical portion.

2. The seal as claimed in claim 1, further comprising two substantially parallel lips.

3. The seal as claimed in claim 2, wherein the two lips are oriented with respect to one another in a form of a V.

4. The seal as claimed in claim 1, wherein the cylindrical portion incorporates a flat on an outer surface.

5. The seal as claimed in claim 4, wherein the flat is diametrically opposed to at least one of the lips.

6. The seal as claimed in claim 5, wherein the longitudinal rib bears with a back against the flat.

7. The seal as claimed in claim 6, wherein the flat is extended by a fastening sole.

8. The seal as claimed in claim 1, wherein from the seal is composed of an elastic material of the glass or aramid fiber-reinforced silicone type.

9. The seal as claimed in claim 1, wherein the seal has a maximum overall size/material thickness ratio of greater than 10.
